(19) United States
(12) Patent Application Publication
(10) Pub. No.: US 2024/0085632 A1
(43) Pub. Date: Mar. 14, 2024

(54) OPTICAL CROSS-CONNECT DEVICE

(71) Applicant: NIPPON TELEGRAPH AND TELEPHONE CORPORATION, Tokyo (JP)

(72) Inventors: Chisato FUKAI, Musashino-shi, Tokyo (JP); Kunihiro TOGE, Musashino-shi, Tokyo (JP); Tomohiro KAWANO, Musashino-shi, Tokyo (JP)

(73) Assignee: NIPPON TELEGRAPH AND TELEPHONE CORPORATION, Tokyo (JP)

(21) Appl. No.: 18/271,982

(22) PCT Filed: Jan. 20, 2021
(86) PCT No.: PCT/JP2021/001781

§ 371 Date: Jul. 12, 2023

(51) Int. Cl. G02B 6/35

(52) U.S. Cl. CPC G02B 6/3504; G02B 6/3546

(57) ABSTRACT

An object of the present disclosure is to enable monitoring of signal light transmitted through an optical cross-connect apparatus to be achieved with low loss and economically, in the optical cross-connect apparatus using a plurality of optical switches connected thereto.

The present disclosure relates to an optical cross-connect apparatus including a plurality of optical path switching means on input/output sides, in which the optical path switching means includes two multi-core optical fibers having different core arrangements, optical coupling between cores of the two multi-core optical fibers is switchable by rotation of at least one of the two multi-core optical fibers, and a first multi-core optical fiber of the two multi-core optical fibers includes a first core that transmits signal light propagated by optical coupling between the cores of the two multi-core optical fibers, and a second core that propagates leakage light of the signal light.

### TECHNICAL FIELD

The present disclosure relates to an optical cross-connect apparatus using a multi-core optical fiber.

### BACKGROUND ART

Various methods have been proposed for an all-optical switch for switching paths of light as they are (see, for example, NPL 1). In an optical cross-connect apparatus including a plurality of optical switches on input/output sides, it is important to monitor signal light transmitted through the optical cross-connect apparatus in order to ensure reliability in a network.

However, when the scale of the optical cross-connect apparatus becomes large and the number of input/output ports increases, optical branching means corresponding to the number of ports are separately required for monitoring the signal light in the optical cross-connect apparatus, which is economically inefficient.

### CITATION LIST

### Patent Literature

[PTL 1] Japanese Patent Application Publication No. H 2-082212
[PTL 2] Japanese Patent Application Publication No. 2016-17019

### Non Patent Literature

[NPL 1] M. Ctepanovsky, “A Comparative Review of MEMS-Based Optical Cross-Connects for All-Optical Networks From the Past to the Present Day,” IEEE Communications, Surveys & Tutorials, vol. 21, No. 3, pp. 2928-2946, 2019.
[NPL 2] Uemura et al., “Fused Taper Type Fan-in/Fan-out Device for 12 Core Multi-Core Fiber,” IEICE Technical Report, OCS 2013-85, 2013.
[NPL 3] T. Matsui, et. al., “Design of 125 μm cladding multi-core fiber with full-band compatibility to conventional single-mode fiber,” 2015 European Conference on Optical Communication, ID 0217, 2015.

### SUMMARY OF INVENTION

### Technical Problem

An object of the present disclosure is to enable monitoring of signal light transmitted through an optical cross-connect apparatus to be achieved with low loss and economically.

### Solution to Problem

An optical cross-connect apparatus of the present disclosure is an optical cross-connect apparatus including a plurality of optical path switching means on input/output sides,
in which the optical path switching means includes two multi-core optical fibers having different core arrangements,
optical coupling between cores of the two multi-core optical fibers is switchable by rotation of at least one of the two multi-core optical fibers, and
a first multi-core optical fiber of the two multi-core optical fibers includes
a first core that transmits signal light propagated by optical coupling between the cores of the two multi-core optical fibers, and
a second core that propagates leakage light of the signal light.

### Advantageous Effects of Invention

According to the present disclosure, since the optical cross-connect apparatus monitors the signal light by using the leakage light of the signal light, both the optical branching of the signal light and the optical branching for monitoring can be shared by the same device, and the monitoring of a plurality of signal light beams transmitted through the optical cross-connect apparatus can be achieved with low loss and economically.

### BRIEF DESCRIPTION OF DRAWINGS

FIG. 1 is a diagram showing an optical path configuration of an optical cross-connect apparatus according to an embodiment of the present disclosure.

FIG. 2 is a schematic diagram showing the principle of an optical switch according to the embodiment of the present disclosure.

FIG. 3 is a schematic diagram showing a cross section of a ferrule on which an MCF is mounted according to a first embodiment of the present disclosure.

FIG. 4 is a schematic diagram showing a cross section of a ferrule on which an MCF is mounted according to the first embodiment of the present disclosure.

FIG. 5 is a schematic diagram showing paths of crosstalk components in an optical switch according to the first embodiment of the present disclosure.

FIG. 6 is a schematic diagram showing paths of crosstalk components in the optical switch according to the first embodiment of the present disclosure.

FIG. 7 is a schematic diagram showing a cross section of a ferrule on which an MCF is mounted according to a second embodiment of the present disclosure.

FIG. 8 is a schematic diagram showing a cross section of a ferrule on which an MCF is mounted according to the second embodiment of the present disclosure.

FIG. 9 is a diagram showing a relationship between a core arrangement radius and static angle accuracy of a multi-core optical fiber and excess loss.

### DESCRIPTION OF EMBODIMENTS

Hereinafter, an embodiment of the present disclosure will be described in detail with reference to the drawings. Note that the present disclosure is not limited to the embodiment described below. These implementation examples are merely examples, and the present disclosure can be implemented in various modified and improved modes based on the knowledge of those skilled in the art. Note that, in the present specification and the drawings, components having the same reference numerals indicate the same components.

Hereinafter, embodiments of the present disclosure will be described in detail with reference to the drawings.

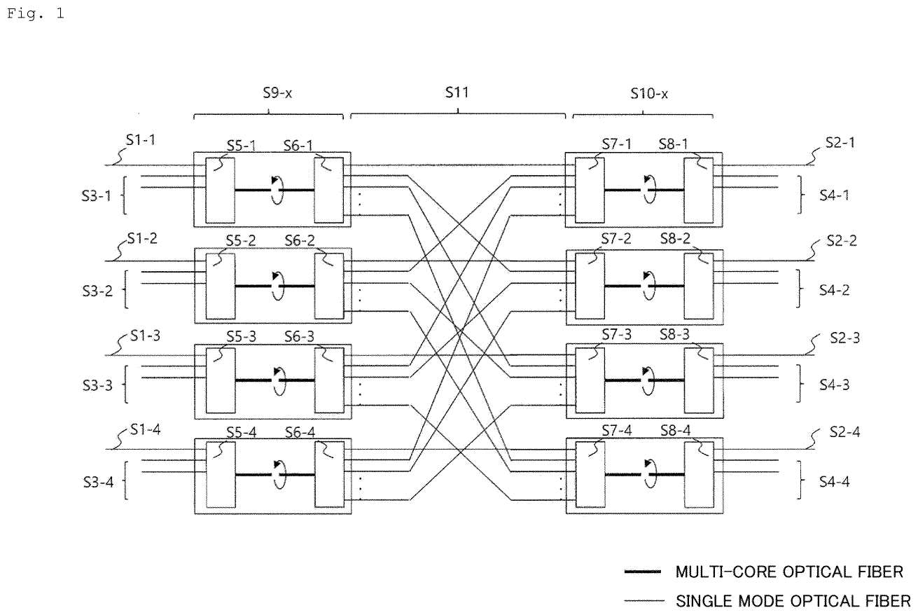

FIG. 1 is a diagram showing an optical path configuration of an optical cross-connect apparatus according to an embodiment of the present disclosure. Here, as an example, a completely non-blocking optical cross-connect apparatus with four inputs and four outputs is shown. The optical cross-connect apparatus includes four optical switches S9-x on one side and four optical switches S10-x on the other side, and spaces between the optical switches S9-x and the optical switches S10-x (S11) are cross-wired with optical fibers having a single core. X is an input/output port number, which means 1 to 4 since the number of ports is 4 in the present embodiment. Also, the optical switches S9-x and 10-x function as optical path switching means.

The optical switches S9-x and S10-x include two multi-core optical fibers (hereinafter referred to as MCFs) having core combining/branching means S5-x and S6-x connected to both ends, and two MCFs having core combining/branching means S7-x and S8-x connected to both ends, respectively. The core combining/branching means S5-x and S6-x couple single mode optical fibers (hereinafter referred to as SMFs) S1-x, S3-x, and S11 having a single core to each core of the MCF, respectively. The core combining/branching means S7-x and S8-x couple SMFs S2-x, S4-x, and S11 having a single core to each core of the MCF, respectively.

The optical switches S9-x and S10-x have a mechanism for rotating either one of the two MCFs, and the mechanism is configured to switch the optical path by switching optical coupling between cores included in the MCF by rotation of the MCF. In addition, the core combining/branching means S5-x, S6-x, S7-x, and S8-x include a fiber bundle type fused tapered mechanism as shown in NPL 2, for example.

The optical switches S9-x and S10-x operate as 1×4 and 4×1 relay optical switches, respectively. Specifically, for example, signal light input to the main path S1-x passes through one of the optical switches S10-x via the optical switch S9-x and the cross wiring S11, and serves as an optical path output to one of the main paths S2-x on the opposite side. The optical cross-connect apparatus according to the embodiment of the present disclosure is capable of bidirectional optical conduction, and conversely, signal light input to the main path S2-x serves as an optical path output to one of the main paths S1-x.

As will be described in detail below, the present disclosure is characterized in that the optical cross-connect apparatus shown in FIG. 1 includes one or more sub-paths S3-x and S4-x which are not the main path of direct signal light, and these sub-paths are used as an optical monitoring means.

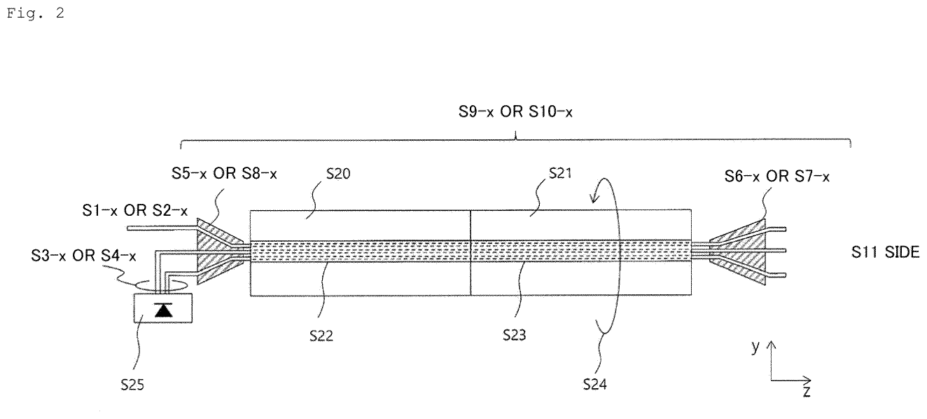

FIG. 2 is a schematic diagram showing the principle of an optical switch included in the optical cross-connect apparatus according to the embodiment of the present disclosure. The central axes of MCFs S22 and S23 are arranged on the same straight line. The optical switch includes a mechanism S24 for rotating one of ferrules S20 and S21 on which the MCFs S22 and S23 are mounted at an arbitrary angle around the ferrule axial direction (z direction), as described in, for example, PTL 1, thereby switching optical coupling between cores between the MCFs S22 and S23. Since the optical switch is composed of almost the same parts as the optical connector, a collimator or vibration isolation mechanism is not required, and it is inexpensive and highly reliable.

At both ends of the MCFs S22 and S23, the core combining/branching means S5-x or S8-x is provided on the input/output side of the main path, and the core combining/branching means S6-x or S7-x is provided on the cross wiring S11 side, respectively. The input/output fibers of the core combining/branching means S5-x or S8-x on the input/output side of the main path are composed of S1-x or S2-x serving as the main path and S3-x or S4-x serving as the sub-path. The sub-path is connected to an optical monitoring means S25. The MCF S22 connected to the core combining/branching means S5-x or S8-x functions as a first multi-core optical fiber, and the MCF S23 connected to the core combining/branching means S6-x or S7-x functions as a second multi-core optical fiber.

The optical monitoring means S25 is a photodetector and serves to monitor signal light propagated from the main path S11 side and transmitted through the optical switch S9-x or S10-x and convert the signal light into an electrical signal.

In FIG. 2, two sub-paths provided in the core combining/branching means S5-x or S8-x are connected to the optical monitoring means S25, but since an amount of received light sufficient to monitor for the presence or absence of signal light is only required to be propagated in the optical monitoring means S25, it is sufficient that the number of the sub-paths is one or more.

### First Embodiment

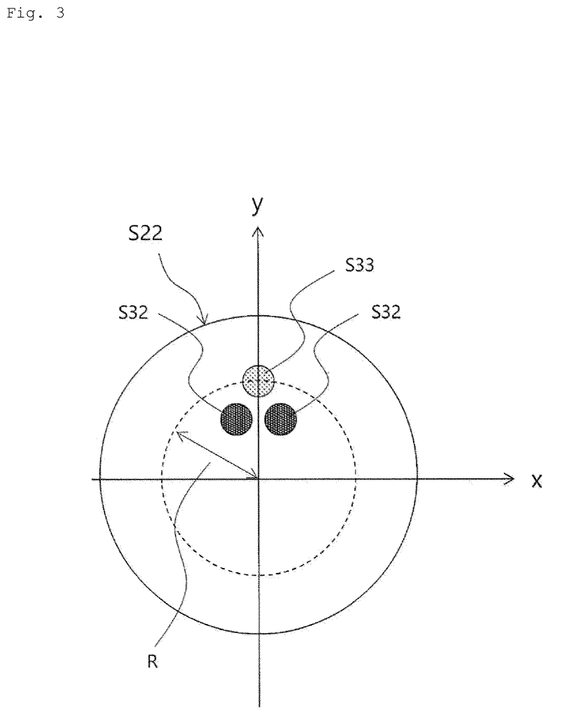

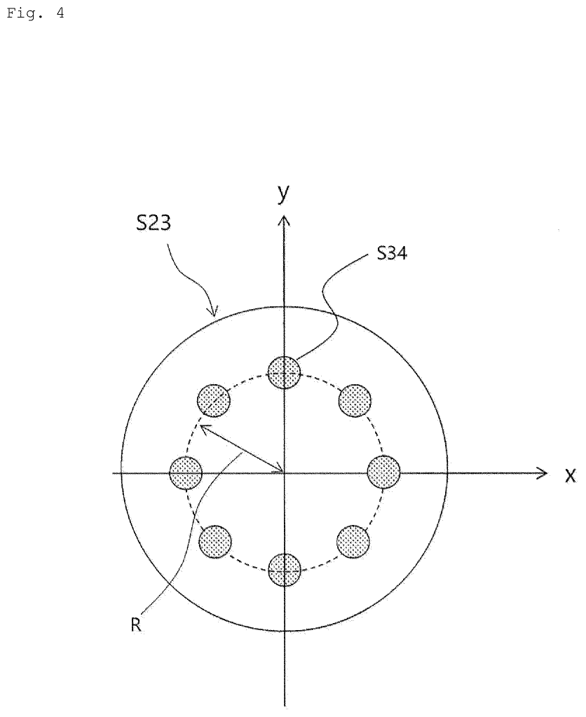

FIGS. 3 and 4 are schematic diagrams showing structures of MCFs S22 and S23 mounted on ferrules S20 and S21 according to a first embodiment of the present disclosure, respectively. Here, the MCFs S22 and S23 used in the optical switches S9-x and S10-x according to the embodiment of the present disclosure are characterized in that the MCF S22 on the input/output side of the main path and MCF S23 on the cross wiring S11 side have mutually different core arrangements.

Specifically, as shown in FIGS. 3 and 4, the MCFs S22 and S23 constituting the optical switch have the same core arrangement radius R. The MCF S22 on the input/output side of the main path includes a core S33 serving as a first core which is a main path on a concentric circle having the core arrangement radius R, and includes cores S32 serving as a second core which are at least one or more sub-paths at positions different from the core S33. The MCF S23 on the cross wiring S11 side includes a plurality of cores S34 on a concentric circle having the core arrangement radius R. These MCFs S22 and S23 can be produced by using the method of PTL 2, for example.

In this way, in the present disclosure, the cores S33 and S34 are arranged at positions at a certain distance from the central axes of the MCFs S22 and S23, and at least one of the MCFs S22 and S23 rotates around the central axis, thereby optically coupling any of the cores S34 and the core S33. Each of the cores S34 is connected to an SMF having a single core in the core combining/branching means S6-x or S7-x. The core combining/branching means S6-x and S7-x are cross-wired with each other. Therefore, by switching the cores S34 optically coupled with the core S33, the connection destinations of the core combining/branching means S6-x and S7-x can be switched.

The core S33 serving as the main path and the core S32 serving as the sub-path of the MCF S22 are optically coupled in the core combining/branching means S5-x and S8-x so that the core profile, inter-core distance, and coupling length are adjusted so as to generate desired crosstalk.

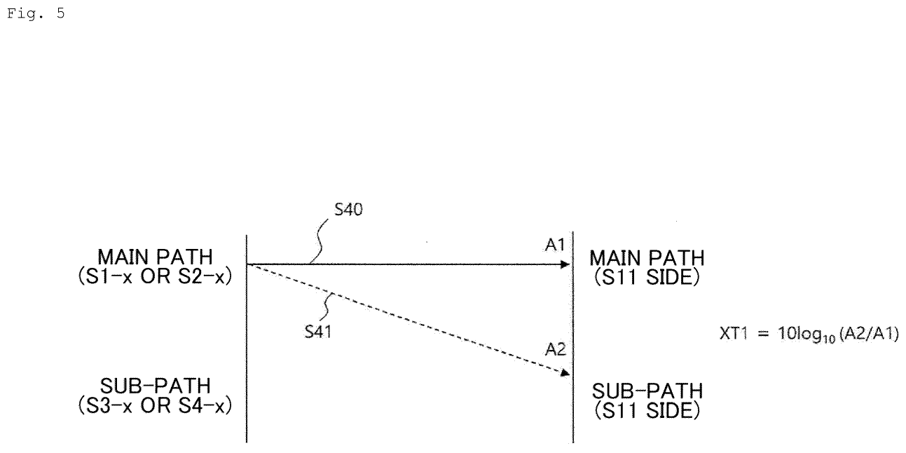

FIG. 5 is a schematic diagram showing paths of crosstalk components in the optical switches S9-x and Sl0-x according to the first embodiment of the present disclosure. As shown in FIG. 5, most of light S40 incident from the main path S1-x or S2-x on the input/output side of the optical cross-connect apparatus is transmitted to the main path (S11 side). The transmission power is defined as A1. At this time, part of the light becomes a crosstalk component S41 and is transmitted to the sub-path (S11 side). The transmission power is defined as A2. At this time, A1>>A2 is satisfied. At this time, the crosstalk coefficient generated from the input/output side of the optical switch toward the cross wiring side is given by the following Equation;

[Math. 1]

XT1=10×log₁₀(A2/A1) (1)

(unit: decibel). For XT1, in the optical cross-connect apparatus, the characteristic of the core combining/branching means S6-x or S7-x arranged on the cross wiring side is dominant, and for example, as in the example described in NPL 3, it is possible to design XT1=−50 dB or less at a wavelength of 1,550 nm.

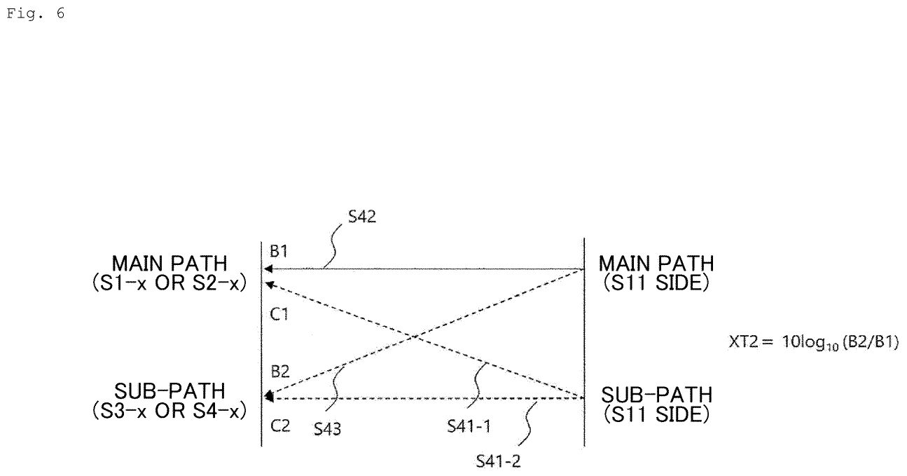

Similarly in the opposite case, as shown in FIG. 6, most of light S42 input from the main path (S11 side) is transmitted to the main path S1-x or S2-x. The transmission power is defined as B1. At this time, part of the light becomes a crosstalk component S43 and is transmitted to the sub-path S3-x or S4-x. The transmission power is defined as B2. At this time, B1>>B2 is satisfied. The embodiment of the present disclosure is characterized in that the crosstalk component S43 is guided to the optical monitoring means S25 and detected. At this time, the crosstalk coefficient generated from the cross wiring side to the input/output side of the optical switch is given by the following Equation;

[Math. 2]

XT2=10×log₁₀(B2/B1) (2)

(unit: decibel). In this case, the crosstalk XT2 is characterized in that, in the optical cross-connect apparatus, the characteristic of core combining/branching means S5-x or S8-x arranged on the input/output side of the main path is dominant, and it is sufficiently larger than the crosstalk coefficient XT1. For example, XT2 is set to −20 dB when approximately 1% of power B1 through which the signal light is transmitted is guided to the optical monitoring means S25.

As a method for realizing the crosstalk XT2, it can be adjusted by changing the inter-core distance between the core S33 serving as the main path and the core S32 serving as the sub-path or by changing the length of the MCF S22 in the MCF S22 on the input/output side of the main path. Further, it is also possible to adjust the crosstalk coefficient so as to obtain a desired crosstalk coefficient in the core combining/branching means S5-x or S8-x on the input/output side of the main path.

The crosstalk component S41 in FIG. 5 is an input to another optical switch facing the optical cross-connect apparatus via the cross-wiring section S11 in the configuration of the optical cross-connect apparatus according to the embodiment of the present disclosure, which corresponds to S41-1 and S41-2 in FIG. 6. When the powers of these components transmitted to the main path and the sub-path are defined as C1 and C2, respectively, the crosstalk equivalent to at least XT1 is experienced again before output from the main path, and for the signal light transmitted through the main path from S40 to S42 with low loss, C1 transmitted through S41 to S41-1 has a sufficiently small power, and B1>>C1 is satisfied, which is unproblematic. In addition, since C2 transmitted from S41 to S41-2 is not coupled to the core of the MCF used for the optical switch, light hardly conducts and C2 can be ignored. In this way, one of a plurality of input/output optical fibers included in the core combining/branching means on an input/output side of a main path constituting an optical switch on one side of the optical cross-connect apparatus according to the first embodiment of the present disclosure is used as a main path of signal light, and at least one or more of the other plurality of optical fibers are used as sub-paths connecting to the optical monitoring means input from the other side of the optical cross-connect apparatus.

Further, an MCF on an input/output side of a main path constituting the optical switch includes a core which is a main path on a concentric circle having the same core arrangement radius as that of the MCF on the cross wiring side and a core conducting to the sub-path on a concentric circle having a different core arrangement radius, and guides part of the signal light to the optical monitoring means using crosstalk from the main path to the sub-path. Therefore, in the optical cross-connect apparatus including a plurality of optical switches using the MCF and the core combining/branching means as in the present embodiment, both the core combining/branching and the optical branching for monitoring can be shared by the same device in the core combining/branching means constituting the optical switch, and the monitoring of a plurality of input/output ports can be achieved with low loss and economically.

The optical monitoring means of the optical cross-connect apparatus according to the embodiment of the present disclosure is a method for monitoring the presence of transmitted signal light, accurately the presence of crosstalk of transmitted signal light on an output side. Therefore, in order to create a list of port numbers on both sides of the optical cross-connect apparatus and the presence/absence of use thereof, although it is necessary to know from which counter port the monitored signal light is input on the basis of the path states of the optical switches S9-x and S10-x, it is easy to know the state of the optical path in advance by using, for example, the control log of the optical switch.

In addition, since the optical monitoring means of the optical cross-connect apparatus according to the embodiment of the present disclosure is a method for monitoring the presence of transmitted signal light, accurately the presence of crosstalk of transmitted signal light on the output side, in order to create a list of port numbers on both sides of the optical cross-connect apparatus and input/output levels thereof, it is necessary to know in advance the transmission loss of the main path of the optical cross-connect apparatus and the crosstalk of at least one or more sub-paths connected to the optical monitoring means. This can be easily known by measuring the characteristics of the device in advance, for example, in the same manner as in the conventional optical monitoring method in which the transmission loss of an optical branching device to be inserted is known in advance in the related art. However, since the transmission loss of the optical switches S9-x and S10-x varies depending on the state of the optical path (that is, core coupling state), it is important to know in advance including the uniformity of the transmission loss due to the path state, and it is possible to create a list of port numbers and input/output levels thereof within a certain range of accuracy.

According to the present disclosure, in an optical cross-connect apparatus including a plurality of optical switches using an MCF and a core combining/branching means, an optical fiber that does not serve as a main path is used as an optical path for guiding the optical fiber to an optical monitoring means, thereby eliminating the need for separately inserting an optical branching device into the main path, and achieving an optical cross-connect apparatus having a low-loss and economical input/output port monitoring function.

### Second Embodiment

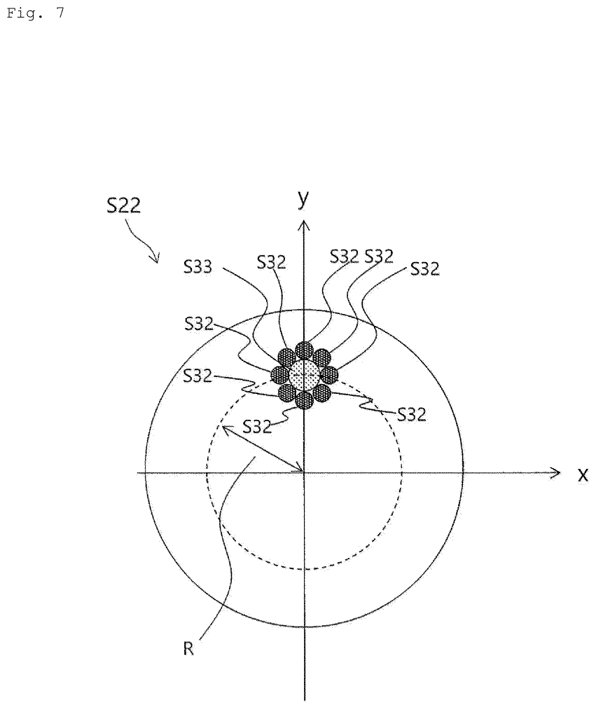

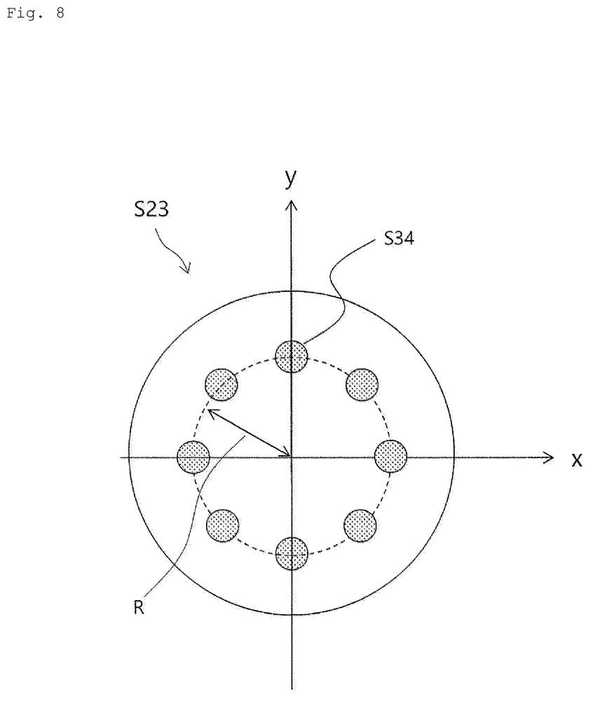

FIGS. 7 and 8 are schematic diagrams showing structures of MCFs S22 and S23 mounted on ferrules S20 and S21 according to a second embodiment of the present disclosure, respectively. Here, the MCFs used in the optical switches according to the embodiment of the present disclosure are characterized in that the MCF S22 on the input/output side of the main path and MCF S23 on the cross wiring S11 side have mutually different core arrangements.

Specifically, as shown in FIGS. 7 and 8, the MCFs S22 and S23 constituting the optical switch have the same core arrangement radius R. The MCF S22 on the input/output side of the main path includes a core S33 serving as a main path on a concentric circle having the core arrangement radius R, and includes cores S32 serving as at least one or more sub-paths around the core S33 serving as the main path. The MCF S23 on the cross wiring S11 side includes a plurality of cores S34 on a concentric circle having the core arrangement radius R.

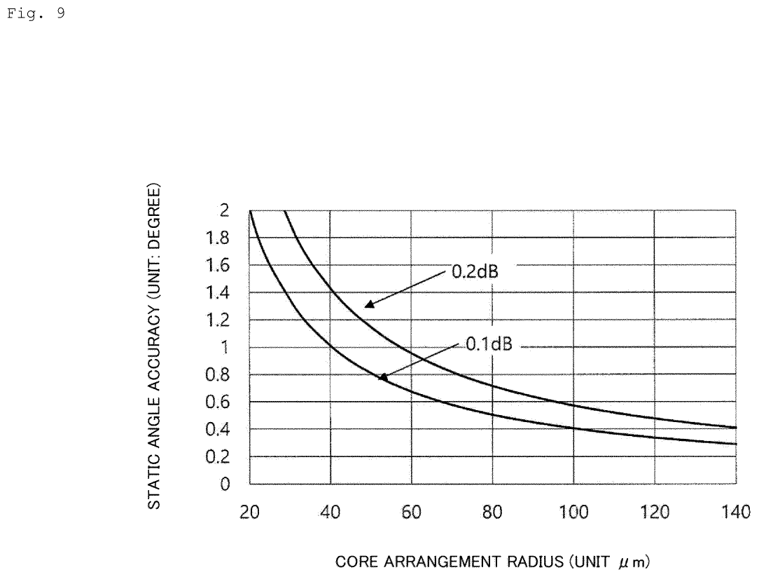

FIG. 9 is a diagram showing the relationship between the core arrangement radius and the static angle accuracy in the rotation of the optical path and the excess loss due to the rotation angle deviation. When the core arrangement radius is defined as R (unit: μm), an excess loss T_{R} (unit: dB) due to the rotation angle deviation in each optical path can be expressed by the following equation using a static angle accuracy θ (unit: degree) in the rotation of the optical path and mode field diameters w₁ and w₂ of the input side and output side optical paths.

$$\begin{matrix}[ Math . 3 ] & \\ {T}_{R} = {( \frac{2 {w}_{1} {w}_{2}}{{{w}_{1}}^{2} + {{w}_{2}}^{2}} )}^{2} exp [ 1 \frac{2 {( 2 R sin 2 π \frac{θ}{360} )}^{2}}{{{w}_{1}}^{2} + {{w}_{2}}^{2}} ] & ( 3 )\end{matrix}$$

When the core arrangement radius R of the optical path is, for example, 60 μm, and the static angle accuracy θ in the rotation of the optical path is 1 degree, the excess loss T_{R} is 0.2 dB, and the lost light leaks to the outside of the core. Also, in the connection between fibers, a loss caused by axial deviation is generally also generated as a main factor of the connection loss. Therefore, by arranging a core S34 serving as a sub-path around the core S33 serving as the main path, a connection loss component due to rotational deviation or axial deviation of the core S33 serving as the main path leaks to the periphery of the core S33 serving as the main path, and the leakage light is coupled to the sub-path and propagated from the sub-path to the optical monitoring means, thereby monitoring the input/output port.

In addition, the core S33 serving as the main path and the core S32 serving as the sub-path of the MCF S22 are not optically coupled in the core combining/branching means S5-x and S8-x, the core profiles of the core S33 serving as the main path and the core S32 serving as the sub-path are adjusted so that the signal light mainly propagates through the core serving as the main path and the leakage light propagates through the core serving as the sub-path. For example, it is possible by adjusting the relationship among a refractive index n1 of the core S33 serving as the main path, a refractive index n2 of the core S32 serving as the sub-path, and a refractive index n3 of the clad so that n1>n2>n3.

In this way, one of a plurality of input/output optical fibers included in the core combining/branching means on an input/output side of a main path constituting an optical switch on one side of the optical cross-connect apparatus according to the second embodiment of the present disclosure is used as a main path of signal light, and at least one or more of the other plurality of optical fibers are used as sub-paths connecting to the optical monitoring means input from the other side of the optical cross-connect apparatus.

Further, an MCF on an input/output side of a main path constituting the optical switch is characterized in that the MCF includes a core which is a main path on a concentric circle having the same core arrangement radius as that of the MCF on the cross wiring side and a core conducting to the sub-path around the core serving as the main path, and guides part of the signal light to the optical monitoring means by utilizing leakage light caused by rotational deviation or axial deviation, which is coupled to the sub-path at the connection between the main path and the MCF on the cross wiring side.

Therefore, in the optical cross-connect apparatus including a plurality of optical switches using the MCF and the core combining/branching means as in the present embodiment, both the core combining/branching and the optical branching for monitoring can be shared by the same device in the core combining/branching means constituting the optical switch, and the monitoring of a plurality of input/output ports can be achieved with low loss and economically.

The optical monitoring means of the optical cross-connect apparatus according to the second embodiment of the present disclosure is a method for monitoring the presence of transmitted signal light, accurately the presence of leaked signal light on an output side. Therefore, in order to create a list of port numbers on both sides of the optical cross-connect apparatus and the presence/absence of use thereof, although it is necessary to know from which counter port the monitored signal light is input on the basis of the path states of the optical switches S9-x and S10-x, it is easy to know the state of the optical path in advance by using, for example, the control log of the optical switch.

In addition, the optical monitoring means of the optical cross-connect apparatus according to the embodiment of the present disclosure is a method for monitoring the presence of transmitted signal light, accurately the presence of leaked signal light on the output side. Therefore, in order to create a list of port numbers on both sides of the optical cross-connect apparatus and input/output levels thereof, although it is necessary to know in advance the loss caused by rotational deviation of the main path of the optical cross-connect apparatus and the propagation loss of at least one or more sub-paths connected to the optical monitoring means, this can be easily known by measuring the characteristics of the device in advance. However, since the transmission loss of the optical switches S9-x and S10-x varies depending on the state of the optical path (that is, core coupling state) in the rotational deviation loss of the main path, it is important to know in advance including the uniformity of the transmission loss due to the path state, and it is possible to create a list of port numbers and input/output levels thereof within a certain range of accuracy.

According to the present disclosure, in an optical cross-connect apparatus including a plurality of optical switches using an MCF and a core combining/branching means, an optical fiber that does not serve as a main path is used as an optical path for guiding the optical fiber to an optical monitoring means, thereby eliminating the need for separately inserting an optical branching device into the main path, and achieving an optical cross-connect apparatus having a low-loss and economical input/output port monitoring function.

### INDUSTRIAL APPLICABILITY

In view of the above effects, the optical switch according to the present disclosure is low-loss and economical in an optical transmission line using a single mode optical fiber, for example, in an optical access transmission line requiring particularly severe low loss, and can be used as an optical cross-connect apparatus capable of monitoring port states in real time.

### REFERENCE SIGNS LIST

S1-x: Main path
S2-x: Main path
S3-x: Sub-path
S4-x: Sub-path
S5-x: Core combining/branching means
S6-x: Core combining/branching means
S7-x: Core combining/branching means
S8-x: Core combining/branching means
S9-x: Optical switch
S10-x: Optical switch
S11: Cross wiring
S20: Ferrule
S21: Ferrule
S22: MCF
S23: MCF
S24: Ferrule rotating mechanism
S25: Optical monitoring means
S32: Sub-path core
S33: Main path core
S34: Core
S40: Light incident from main path
S41: Crosstalk component
S42: Light incident from main path
S43: Crosstalk component

1. An optical cross-connect apparatus comprising a plurality of optical path switching means on input/output sides, wherein the optical path switching means includes two multi-core optical fibers having different core arrangements,
optical coupling between cores of the two multi-core optical fibers is switchable by rotation of at least one of the two multi-core optical fibers, and
a first multi-core optical fiber of the two multi-core optical fibers includes
a first core that transmits signal light propagated by optical coupling between the cores of the two multi-core optical fibers, and
a second core that propagates leakage light of the signal light.

2. The optical cross-connect apparatus according to claim 1, wherein
the optical path switching means includes a core combining/branching means for converting a plurality of cores of the first multi-core optical fiber into a plurality of optical fibers having a single core, and
the plurality of optical fibers having a single core included in the core
combining/branching means include
a main path through which the signal light propagated in the first core is transmitted, and
a sub-path for propagating the leakage light propagated in the second core to an optical monitoring means.

3. The optical cross-connect apparatus according to claim 2, wherein
the optical path switching means includes
the first multi-core optical fiber in which the first core is arranged at a certain distance from a central axis of the multi-core optical fiber, and
a second multi-core optical fiber having a central axis arranged on the same central axis as the first multi-core optical fiber and having a plurality of cores arranged at the certain distance from the central axis, and
at least one of the first multi-core optical fiber and the second multi-core optical fiber rotates around the central axis to optically couple any core provided in the second multi-core optical fiber and the first core.

4. The optical cross-connect apparatus according to claim 3, wherein the second core is arranged at a distance different from the certain distance from the central axis of the second multi-core optical fiber.

5. The optical cross-connect apparatus according to claim 1, wherein the second core is arranged around the first core.
